(19) United States
(12) Patent Application Publication
(10) Pub. No.: US 2025/0347507 A1
(43) Pub. Date: Nov. 13, 2025

(54) POSITION MEASURING DEVICE

(71) Applicant: DR. JOHANNES HEIDENHAIN GmbH, Traunreut (DE)

(72) Inventors: Johannes Schneider, Traunstein (DE); Johannes Hilverkus, Marquartstein (DE)

(21) Appl. No.: 19/193,998

(22) Filed: Apr. 30, 2025

(30) Foreign Application Priority Data
May 7, 2024 (EP) 24174455.6

(51) Int. Cl. G01B 7/30

(52) U.S. Cl. CPC G01B 7/30

(57) ABSTRACT

A position measuring device including a first component group and a second component group. The first and second component groups are arranged so as to be movable relative to one another in a measurement direction. The first component group has a domain-wall memory including a domain-wall conductor running in a face. The second component group includes a first magnet and a second magnet. The first and second magnets are arranged end to end in the measurement direction, magnetized such that their magnetization directions run with an orthogonal directional component with respect to the face, and arranged such that they have opposite magnetization directions. The magnets are arranged and configured such that a distance in the measurement direction between the first magnet and the second magnet varies in size along a second direction that is oriented orthogonally to the measurement direction.

### CROSS REFERENCE TO RELATED APPLICATIONS

This application claims benefit to European Patent Application No. EP 24174455.6, filed on May 7, 2024, which is hereby incorporated by reference herein.

### FIELD

The invention relates to a position measuring device.

### BACKGROUND

Angular-position measuring devices are used, for example, as rotary encoders for determining the angular position of two machine parts that are rotatable relative to one another. Often, what are known as multi-turn angular-position measuring devices are used for this purpose, which allow for absolute position determination over several revolutions.

In addition, linear measuring devices are known, in which a linear displacement of two machine parts that are displaceable relative to one another is measured. Particularly in linear measuring devices that have a relatively large measurement length, a plurality of linear or identical scales are often mounted end to end in the measurement direction. In these linear measuring devices, absolute position determination should ideally be possible over the entire measurement length.

Often, these measuring devices or measuring instruments are used for electrical drives to determine the relative movement or relative position of relevant machine parts. In this case, the position values generated are supplied to subsequent electronics for actuating the drives by way of a corresponding interface arrangement.

For many applications of position measuring devices, particularly angular-position measuring devices or linear measuring devices, it is important to capture at least numbers of revolutions or rough positions even in the event of temporary power outages, and to store them in a non-volatile manner.

WO 2023/118012 A1 describes a position measuring device for measuring an angular position, comprising a domain-wall memory as a multi-turn sensor. The domain walls thereof can be moved by a single, apparently diametrically magnetized permanent magnet that is rotatable relative to the domain-wall memory.

### SUMMARY

In an embodiment, the present disclosure provides a position measuring device comprising a first component group and a second component group. The first and second component groups are arranged so as to be movable relative to one another in a measurement direction. The first component group has a domain-wall memory comprising a domain-wall conductor running in a face. The second component group comprises a first magnet and a second magnet. The first and second magnets are arranged end to end in the measurement direction, magnetized such that their magnetization directions run with an orthogonal directional component with respect to the face, and arranged such that they have opposite magnetization directions. The magnets are arranged and configured such that a distance in the measurement direction between the first magnet and the second magnet varies in size along a second direction that is oriented orthogonally to the measurement direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a perspective view of a position measuring device according to an embodiment example;

FIG. 2 illustrates a sectional view of a detail of the position measuring device;

FIG. 3 illustrates a plan view of two magnets and a domain-wall conductor;

FIG. 4 illustrates a plan view of the domain-wall conductor;

FIG. 5 illustrates a graph showing a schematic curve of an orientation of a magnetic field as a function of a measurement direction; and

FIG. 6 illustrates a plan view of two magnets together with the domain-wall conductor according to an embodiment example.

### DETAILED DESCRIPTION

In an embodiment, the present disclosure provides a position measuring device that comprises a domain-wall memory and enables precise, reliable operational performance. The domain-wall memory can be configured for storing revolution or position information, for example for an angular-position measuring device or a linear measuring device.

According to an embodiment, the position measuring device comprises a first component group and a second component group, the component groups being arranged so as to be movable relative to one another in a measurement direction. The first component group has a domain-wall memory, which comprises a domain-wall conductor running in a face. The second component group comprises a first magnet and a second magnet, the magnets being able to be configured in particular as permanent magnets. These magnets are arranged end to end in the measurement direction. Furthermore, the magnets are magnetized such that their magnetization directions run with an orthogonal directional component with respect to the face of the domain-wall conductor, the magnets being arranged such that they have opposite magnetization directions. The first magnet and the second magnet are arranged and configured such that the distance between the first magnet and the second magnet in the measurement direction varies in size along a second direction. In this case, the second direction is oriented orthogonally to the measurement direction.

The magnetization directions run with an orthogonal directional component with respect to the face of the domain-wall conductor; in other words, the magnetization directions each have a directional component that is oriented orthogonally to the face. In particular, the magnetization directions can run orthogonally (within the bounds of the usual mounting tolerances) to the face of the domain-wall conductor. In addition, the second direction can also be oriented orthogonally to the magnetization direction. The face in which the domain-wall conductor runs thus extends both along the measurement direction and along the second direction. The normal vector of the face is oriented in a third direction. In other words, the measurement direction is oriented orthogonally to the second direction and orthogonally to the third direction.

Domain-wall conductors configured substantially as an open spiral are known, as are those having a closed shape. With closed shapes in particular, one portion of the domain-wall conductor can run under a different portion of the domain wall in order to avoid crossings. The face of the domain-wall conductor can be understood as the face in which a domain-wall conductor part, running for example in a spiral shape, is arranged (excluding bridging or tunneling).

The geometric considerations described here apply to the spatial region in which the relevant magnet is opposite the domain-wall conductor, “from the perspective” of the domain-wall conductor, as it were. For example, starting from the domain-wall conductor, the magnetization direction runs with an orthogonal directional component or strictly orthogonally to the face of the domain-wall conductor in the third direction, even when the magnets are rotating.

Between the first magnet and the second magnet there is a gap which extends in the measurement direction and the length of which in the measurement direction varies in size along the second direction. The contours, facing one another in the measurement direction, of the ends of the magnets are thus configured such that they diverge at least over a region extending in the second direction.

The magnetization direction can be understood as the direction of a connecting line between the north pole and the south pole of a magnet. The magnets are preferably magnetized through their thickness. In particular, the magnetization direction can be oriented orthogonally to the opposite largest faces of the magnet.

Since there is a distance between the first and the second magnet in the measurement direction, there is an interstice in this region which either consists of air or is filled with largely non-magnetic material.

A domain-wall conductor consists of a magnetizable material and, in the context of the present disclosure, is configured in particular as at least one conducting trace or conducting track or a nanowire. In the domain-wall conductor, information can be stored in the form of regions (domains) of opposite magnetization. The domains are separated along the conducting trace by what are known as domain walls, which can be displaced by magnetic fields, with the positions of the domains changing in the process.

Advantageously, the domain-wall memory comprises an in particular planar substrate, and the domain-wall conductor is configured as a conducting track on the substrate. In this case, the face in which the domain-wall conductor runs is planar. Alternatively, the face could also be configured in a curved manner, in particular if the domain-wall conductor is opposite magnets that have a curved surface.

The structural width of the domain-wall conductor is usually less than 500 nm, often less than 300 nm, and the thickness or layer thickness of the domain-wall conductor is less than 60 nm. The domain-wall memory can comprise a plurality of domain-wall conductors.

The domain-wall memory furthermore has readout elements by which the local magnetization status of the domain-wall conductor (at the position of each readout element) can be determined. A magnetization status of each domain-wall conductor can therefore be determined by the readout elements. The readout elements are arranged in a fixed manner with respect to the domain-wall conductor. GMR or TMR sensors are possible readout elements, for example.

Advantageously, in relation to the second direction, the domain-wall conductor is positioned such that the magnets pass by it in the region of a distance between the magnets that is less than the maximum distance. When the magnets travel past the domain-wall conductor, the domain-wall conductor is located in the region of the relatively small distance between the magnets and is influenced by the magnetic field lines prevailing there. In particular, in relation to the second direction, the domain-wall conductor is positioned such that the magnets pass by it in the region of the smallest distance. When the magnets travel past the domain-wall conductor, the domain-wall conductor is then located in the region of the smallest distance between the magnets and is influenced by the magnetic field lines prevailing there.

In an embodiment of the present disclosure, at least one of the magnets is configured such that it has an asymmetric form with respect to a line running in parallel with the measurement direction and in particular also orthogonally to the magnetization direction. This asymmetry can be obtained in particular by configuring at least one end of one magnet to be asymmetric.

Advantageously, at least one of the magnets is configured at its end such that the contour thereof runs in a curved manner; for example, the contour can roughly run along an elliptical line or along a circular line.

Advantageously, the magnets are configured such that the distance in the measurement direction between the first magnet and the second magnet varies continuously along the second direction. Accordingly, a contour at the end of at least one of the magnets runs continuously, i.e., without any step changes or with a smooth outline, in the region in which the distance varies.

Advantageously, the magnets are arranged end to end in the measurement direction in such a way that they do not touch. Consequently, the minimum distance between the first magnet and the second magnet in the measurement direction is greater than zero.

In an embodiment of the present disclosure, between the domain-wall conductor and the magnets there is an air gap having an extent that extends orthogonally to the face in which the domain-wall conductor runs. In this case, the minimum distance between the first magnet and the second magnet in the measurement direction is less than half the extent of the air gap. In the event that the extent of the air gap is not intended to be the same over the entire face of the domain-wall conductor, then in particular the minimum distance between the magnets is less than half the smallest extent of the air gap.

Advantageously, the component groups are arranged so as to be rotatable relative to one another about an axis, and the axis does not intersect or pass through the face in which the domain-wall conductor runs. In this arrangement, the second direction runs either in the radial direction or in the axial direction (drum arrangement), and the measurement direction corresponds to the circumferential or tangential direction. Often, an arrangement in which the (rotational) axis does not intersect the face in which the domain-wall conductor runs is referred to as an “off-axis” configuration. In this configuration too, the second direction is always oriented orthogonally to the measurement direction. In particular, the second direction also runs orthogonally to the magnetization direction.

According to an embodiment of the position measuring device, the domain-wall conductor has a non-closed shape, having a start and an end, as opposed to a closed shape, in which the domain-wall conductor is configured to be continuous. In particular, the domain-wall conductor can be configured as an open spiral.

In an embodiment of the present disclosure, in the measurement direction the domain-wall conductor has a maximum extent which is less than the length, extending in the measurement direction, of one of the magnets.

Advantageously, in the second direction the domain-wall conductor has a maximum extent which is less than the width, likewise extending in the second direction, of one of the magnets.

Advantageously, the material of which at least one of the magnets is made comprises a plastics material having a magnetizable filler. In particular, at least one of the magnets can be produced by a pressing method or an injection molding method. Alternatively, the magnet can also be produced by a sintering method or a casting method.

In an embodiment of the present disclosure, the contours of the mutually facing ends of the magnets run in mirror symmetry with respect to an axis of symmetry that is oriented in parallel with the second direction.

Advantageously, the magnets are configured to be identical or structurally identical.

The position measuring device can be used as an angular-position measuring device in which numbers of revolutions in particular are stored. Alternatively, the position measuring device can be configured as a linear measuring instrument having a linear scale for measuring linear displacements. The scale can in particular comprise a first scale part and a second scale part. The first scale part and the second scale part can, for example, be arranged end to end along the measurement direction such that a relatively large measurement length can be obtained. In practice, of course, more than just two scale parts can be arranged end to end. Magnets are then provided in a manner offset from one another along the first direction. Using the domain-wall memory, corresponding position information can be stored so that it can be established which of the scale parts is currently being read.

Further details and advantages of the position measuring device according to the present disclosure will become apparent from the following description of embodiment examples with reference to the accompanying drawings.

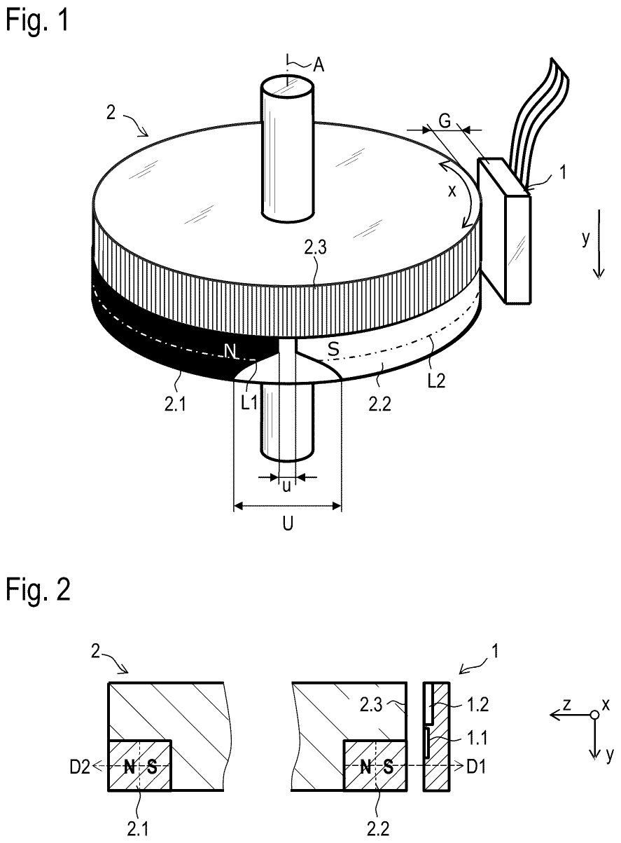

FIG. 1 shows a position measuring device that comprises a first component group 1 and a second component group 2, the component groups 1, 2 being arranged so as to be rotatable relative to one another about an axis A.

In the first embodiment example shown, the second component group 2 is configured as a drum or disk and in this case has, on the outer casing, a scale 2.3 or a graduation extending in a measurement direction x.

A first magnet 2.1 and a second magnet 2.2 are arranged in a manner axially offset from the scale 2.3, the magnets 2.1, 2.2 being assigned to the second component group 2. The magnets 2.1 and 2.2 and the scale 2.3 are thus each rigidly interconnected and move or rotate at the same rate or speed. The magnets 2.1, 2.2 are arranged end to end in the measurement direction x, which here corresponds to the circumferential direction, and each have a midline L1, L2 extending in the measurement direction x. In addition, the magnets 2.1, 2.2 are configured as permanent magnets and are each magnetized through their thickness, i.e., such that their magnetization directions D1, D2 are oriented radially (see also FIG. 2).

In the embodiment example shown, the magnets 2.1, 2.2 are configured as plastics-bonded magnets. Accordingly, they comprise plastics material having a magnetizable filler or magnetic powder. The filler is embedded in a plastics matrix. In particular, the magnets 2.1, 2.2 can be configured as pressed magnets, the magnetizable filler being embedded in a thermosetting plastics matrix, e.g., epoxy resin. Alternatively, the magnets 2.1, 2.2 can also be produced in an injection molding method.

The magnets 2.1, 2.2 are arranged such that they have opposite magnetization directions D1, D2. In the embodiment example shown, the first magnet 2.1 has its north pole radially at the outside on the outer casing whereas the second magnet 2.2 has its south pole radially at the outside on the outer casing.

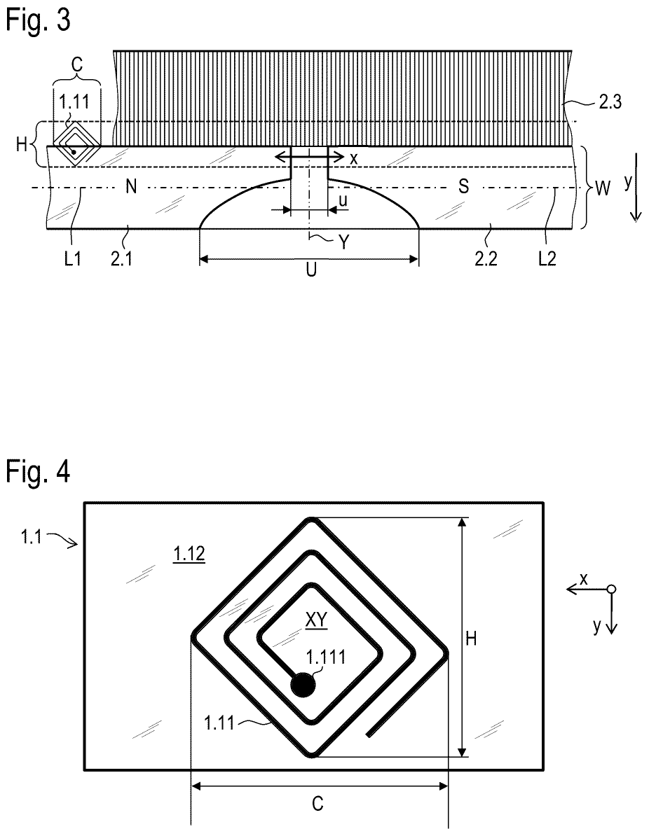

The ends of the magnets 2.1, 2.2 are configured such as to taper. Accordingly, the first magnet 2.1 and the second magnet 2.2 are configured such that the distance u, U extending in the measurement direction x between the first magnet 2.1 and the second magnet 2.2 varies when said distance is ascertained at different points along a second direction y. In FIG. 3, the distance u, U increases along the second direction y from the top down following the arrow. The second direction y runs orthogonally to the measurement direction x, i.e., in this case in parallel with the axis A or in the axial direction. Thus, the distance u, U varies in size along the second direction y or in accordance with a position along the second direction y. The contours of the mutually facing ends of the magnets 2.1, 2.2 are configured in mirror symmetry with respect to an axis of symmetry Y (FIG. 3) that is oriented in parallel with the second direction y. In addition, the ends of the magnets 2.1, 2.2 are configured such that their contours run asymmetrically with respect to a line that is oriented in parallel with the measurement direction x, in particular with respect to the midline L1, L2. In the region in which the distance u, U in the measurement direction x between the magnets 2.1, 2.2 varies, the first magnet 2.1 and the second magnet 2.2 or their contours are configured such that said distance u, U varies continuously along the second direction y, i.e., such that the contours there are configured as smooth curves and without any step changes along the second direction y.

In accordance with FIG. 2, the first component group 1 comprises a domain-wall memory 1.1 and a position detector 1.2, by which the scale 2.3 can be read and the scale information can be converted into electrical signals. By way of example, the scale 2.3 can be configured as an optical graduation, in which case the position detector 1.2 then comprises a light source and photodetectors. Alternatively, the graduation can also be configured as a magnetic graduation, in which case the position detector 1.2 would comprise magnetoresistive elements or, for example, Hall elements. Likewise, it is possible to use an inductive reading principle to determine the position. In the latter case, the graduation would be configured accordingly.

In accordance with FIG. 4, the domain-wall memory 1.1 comprises a domain-wall conductor 1.11 and a substrate 1.12, the domain-wall conductor 1.11 being applied to the substrate 1.12 in the form of a conducting track and running in (or on) a first face XY. At one end, the domain-wall conductor 1.11 has a domain-wall generator 1.111. In the embodiment example shown, the substrate 1.12 has a mechanically load-bearing silicon layer, the substrate 1.12 being configured in a planar manner and it being possible for the domain-wall conductor 1.11 to be part of a CMOS chip. Alternatively, the substrate can have a glass layer. The domain-wall conductor 1.11 comprises a magnetically soft material, for example a Ni—Fe alloy. The domain-wall conductor 1.11 can be configured as an open spiral, as shown in FIG. 4, or have a closed shape.

When the position measuring device is in operation, the first component group 1 and the second component group 2 are opposite each other. In the embodiment example shown, the first component group 1 can be operated as the stator and the second component group 2 as the rotor.

The scale 2.3 is then read by the position detector 1.2 (FIG. 2); this delivers electrical signals which contain the position information and which can be conducted to further electronics via a cable.

The domain-wall memory 1.1 is used for ensuring a multi-turn functionality, i.e., for counting several revolutions or passes. The domain-wall memory 1.1 is arranged such that the face XY in which the domain-wall conductor 1.11 runs (or is arranged) is oriented orthogonally to the magnetization direction D1, D2.

According to FIGS. 3 and 4, the domain-wall conductor 1.11 has a maximum extent H in the second direction y and a maximum extent C in the measurement direction x. In addition, the domain-wall conductor 1.11 is arranged in a manner offset from the midlines L1, L2 of the magnets 2.1, 2.2 in the second direction y, in this case in the axial direction.

To even out the magnetic field in the region of the transition from the first magnet 2.1 to the second magnet 2.2, the minimum distance u is in this case selected to be greater than zero. Moreover, the size of the minimum distance u between the first and the second magnet 2.1, 2.2 is such as to be less than half the extent G of the air gap between the domain-wall conductor 1.11 and the magnets 2.1, 2.2 (u<½ G).

FIG. 3 is a simplified view of a detail of the position measuring device. The two dashed lines are intended to show the movement trace of the domain-wall conductor 1.11 during the relative movement of the two component groups 1, 2. It is clear from this figure that the domain-wall conductor 1.11 is offset from the midlines L1, L2 of the magnets 2.1, 2.2 to such an extent that no region of the domain-wall conductor 1.11 extends over the midlines L1, L2, i.e., the domain-wall conductor 1.11 is arranged outside the midlines L1, L2 over the entire extent H.

In addition, the magnets 2.1, 2.2 have a width W extending in the second direction y. Here, the maximum extent H of the domain-wall conductor 1.11 in the second direction y is less than the width W of the magnets 2.1, 2.2 (H<W). In addition, the maximum extent C of the domain-wall conductor 1.11 in the measurement direction x is less than the length, extending in the measurement direction x, of one of the magnets 2.1, 2.2. The contours of the mutually facing ends of the magnets 2.1, 2.2 are configured in mirror symmetry or in axial symmetry with respect to an axis of symmetry Y that is oriented in parallel with the second direction y.

When a magnetic field moving relative to the domain-wall conductor 1.11 acts suitably on the domain-wall conductor 1.11, domain walls are displaced within or along the domain-wall conductor 1.11. To create an optimized magnetic field, a magnet arrangement as described above is used, comprising the magnets 2.1, 2.2 that have tapers at each of the mutually facing ends of the magnets 2.1, 2.2. It has proven extremely advantageous if, as in the embodiment example, the contour of each end of a magnet 2.1, 2.2 runs in a curved manner such that the magnets 2.1, 2.2 have a concave portion at each of their ends.

In relation to the second direction y, the domain-wall conductor 1.11 is positioned such that the magnets 2.1, 2.2 pass by it in the region of the smallest distance u. If the magnets 2.1, 2.2 now move relative to the domain-wall conductor 1.11 in the measurement direction x, a magnetic field that is rotating, so to speak, in the plane of the domain-wall conductor 1.11, i.e., in the face XY, acts on the domain-wall conductor 1.11 at the ends and in particular in the region of the gap between the magnets 2.1, 2.2. As a result, the positions of domain walls are displaced, the displacement field being generated by the magnets 2.1, 2.2 being guided past the domain-wall conductor 1.11.

After each time the ends of the magnets 2.1, 2.2 travel past the domain-wall conductor 1.11, or after each half-revolution of the second component group 2, the domain wall or walls move further.

The magnetization directions within portions of the domain-wall conductor 1.11, and thus the positions of the domain walls, can be detected by the readout elements integrated in the domain-wall memory 1.1. In this way, in an angular-position measuring device, revolutions can be counted or the revolution information stored even when no auxiliary power can be used. By way of example, this is important if a shaft is moved, for example under a weight load, during a power outage. Moreover, the domain walls are displaced in a manner dependent on the direction of rotation such that the domain-wall memory 1.1 can be used reliably in applications that allow for both directions of rotation.

The reading of the scale 2.3 by the position detector 1.2 yields a relatively accurate determination of the angular position within one revolution. For the absolute determination of the angular position over a plurality of revolutions, the angular position (fine position) ascertained by the position detector 1.2 has to be synchronized with the revolution information (rough position) of the domain-wall conductor 1.1.

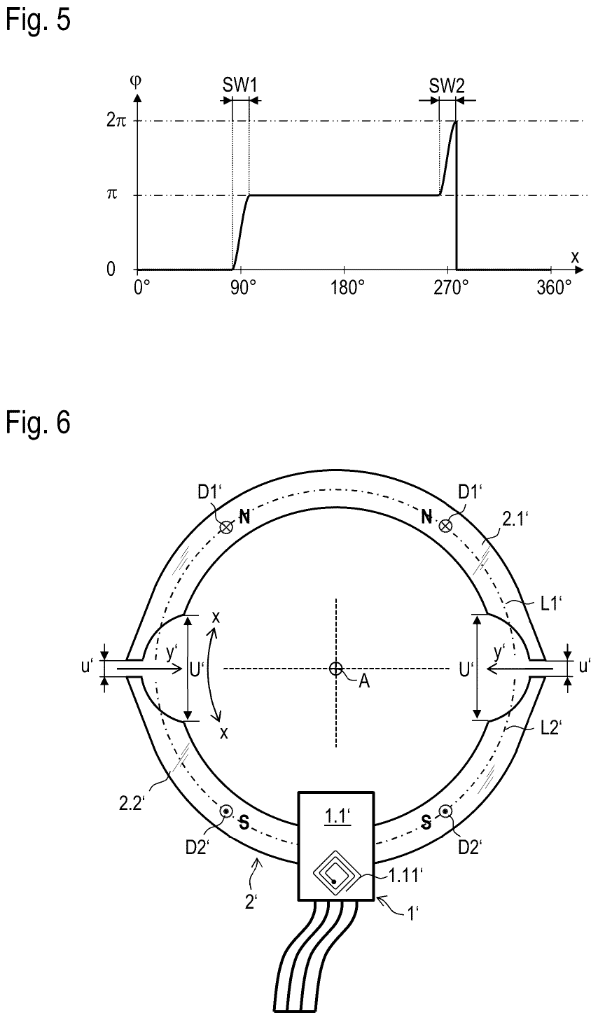

FIG. 5 is a schematic graph in which the angular orientation j of the magnetic field (magnetic angle) is plotted against the measurement direction x. The angular orientation j of the magnetic field is observed in the face XY in which the domain-wall conductor 1.11 runs, in particular in the middle of the spiral (centroid of the spiral), the face XY extending over the extent C and the extent H according to FIG. 4.

At the start of the rotational movement, the arrangement is in a position according to FIG. 1, where x=0°. At the domain-wall conductor 1.11, the two magnets 2.1, 2.2 generate a magnetic field which, when the second component group 2 rotates about the axis A through approximately one quarter of a revolution, constantly has the orientation j=0. It is only when the end of the second magnet 2.2 is reached that the orientation j of the magnetic field changes and the second component group 2 moves into a first transition region SW1. When the second component group 2 rotates further together with the magnets 2.1, 2.2, the orientation j of the magnetic field changes from j=0 to j=p in the first transition region SW1, and the domain wall(s) is/are displaced further, or a new domain wall is generated or deleted. Upon further rotation up to just before the end of the first magnet 2.1, the orientation j of the magnetic field remains at j=p. The orientation of the magnetic field changes from p to 2p. only after the second transition region SW2 from the first magnet 2.1 to the second magnet 2.2. At this transition too, there is a transition region SW2 (either side of x=270°), in which the orientation j of the magnetic field takes on an interim value. Afterwards, the magnetic orientation is the same as when x=0, for which, by definition, j=2p=0. Outside the transition regions SW1, SW2, the orientation j of the magnetic field is directed such that no movement of the domain wall(s) is possible there, and no new domain wall can be generated or deleted either. The invention makes it possible to keep the transition regions SW1, SW2 relatively small (in relation to the measurement direction x), such that mechanical hysteresis effects are minimized.

According to a second embodiment example in accordance with FIG. 6, the domain-wall memory 1.1′ of the first component group 1 is arranged at an axial distance from the first magnet 2.1F and the second magnet 2.2′ of the second component group 2′. In the second embodiment example, too, the magnets 2.1′, 2.2′ are arranged end to end in the measurement direction x, which here again corresponds to the circumferential direction, and each have a midline L1′, L2′ extending in the measurement direction x. In this case, the second direction y′ runs in the radial direction. In addition, the magnets 2.1′, 2.2′ are configured as permanent magnets and are each magnetized through their thickness, i.e., such that their magnetization directions D1′, D2′ are oriented axially in this case. The magnets 2.1′, 2.2′ have opposite magnetization directions D1′, D2′. In the embodiment example shown, the two magnets 2.1′, 2.2′ are identical, which is advantageous for assembly and stockkeeping.

In the second embodiment example, too, the ends of the magnets 2.1′, 2.2′ are configured so as to taper, such that the first magnet 2.1′ and the second magnet 2.2′, the distance u′, U′ extending in the measurement direction x between the magnets 2.1′, 2.2′, varies when said distance is ascertained at different points along the second direction y. The second direction y runs orthogonally to the measurement direction x and orthogonally to the magnetization directions D1′, D2′, i.e., in the radial direction here. Thus, the distance u′, U′ varies in size along the second direction y′.

In this embodiment, the domain-wall conductor 1.11′ is arranged “off-axis”; in other words, the axis A runs next to the domain-wall conductor 1.11′ and does not intersect it.

The present disclosure can also be used in position measuring devices for measuring linear displacements. This would correspond to an arrangement according to FIG. 1, the drum of which would have an infinite radius. In this case, a plurality of scales 2.3 would be mounted end to end in the measurement direction x. The plan view of the magnets 2.1, 2.2 for a linear measuring devices corresponds in principle to the view according to FIG. 3.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A position measuring device comprising:
a first component group; and
a second component group,
wherein the first and second component groups are arranged so as to be movable relative to one another in a measurement direction,
wherein the first component group has a domain-wall memory comprising a domain-wall conductor running in a face,
wherein the second component group comprises a first magnet and a second magnet, wherein the first and second magnets are:
arranged end to end in the measurement direction,
magnetized such that their magnetization directions run with an orthogonal directional component with respect to the face, and
arranged such that the first and second magnets have opposite magnetization directions,
wherein the magnets are arranged and configured such that a distance in the measurement direction between the first magnet and the second magnet varies in size along a second direction that is oriented orthogonally to the measurement direction.

2. The position measuring device according to claim 1, wherein, in relation to the second direction, the domain-wall conductor is positioned such that the first and second magnets travel past the domain-wall conductor in a region of a first distance in the measurement direction between the first magnet and the second magnet that is less than a greatest distance in the measurement direction between the first magnet and the second magnet.

3. The position measuring device according to claim 1, wherein at least one of the first and second magnets is configured at its end such that a contour thereof extends in a curved manner.

4. The position measuring device according to claim 1, wherein at least one of the first and second magnets is configured to be asymmetric with respect to a line extending in parallel with the measurement direction.

5. The position measuring device according to claim 1 wherein the distance in the measurement direction between the first magnet and the second magnet varies continuously along the second direction.

6. The position measuring device according to claim 1, wherein an air gap having an extent that extends orthogonally to the face is arranged between the domain-wall conductor and the first and second magnets, and wherein a minimum distance in the measurement direction between the first magnet and the second magnet is less than half the extent of the air gap.

7. The position measuring device according to claim 1, wherein the first and second magnets are arranged end to end in the measurement direction such that the first and second magnets do not touch.

8. The position measuring device according to claim 1, wherein the first and second component groups are configured to rotate relative to one another about an axis, and the face in which the domain-wall conductor runs is not intersected by the axis.

9. The position measuring device according to claim 1, wherein the domain-wall conductor has a non-closed shape.

10. The position measuring device according to claim 1, wherein in the measurement direction the domain-wall conductor has a maximum extent which is less than a length, extending in the measurement direction, of one of the first and second magnets.

11. The position measuring device according to claim 1, wherein in the second direction the domain-wall conductor has a maximum extent which is less than a width, extending in the second direction, of one of the first and second magnets.

12. The position measuring device according to claim 1, wherein a material of at least one of the first and second magnets comprises plastics material having a magnetizable filler.

13. The position measuring device according to claim 1, wherein contours of mutually facing ends of the first and second magnets are configured in mirror symmetry with respect to an axis of symmetry that is oriented in parallel with the second direction.

14. The position measuring device according to claim 1, wherein the first and second magnets are configured to be identical.
